(19) United States
(12) Patent Application Publication
(10) Pub. No.: US 2005/0180078 A1
(43) Pub. Date: Aug. 18, 2005

(54) Solenoid protection method and apparatus

(75) Inventors: Thomas J. Sievers, Laguna Niguel, CA (US); Morteza Yadollahi, Irvine, CA (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Adams Rite Aerospace, Inc.

(21) Appl. No.: 11/049,929

(22) Filed: Feb. 4, 2005

Related U.S. Application Data
(60) Provisional application No. 60/543,995, filed on Feb. 13, 2004.

(51) Int. Cl. H02H 5/04

(52) U.S. Cl. 361/103

(57) ABSTRACT

An overtemperature protection method and apparatus for a solenoid applies the property of thermal sensitivity of positive temperature coefficient resistors (PTCRs) to prevent heat-induced failures, even in the absence of overcurrent conditions, while effectively preventing nuisance tripping.

### CLAIM OF PRIORITY

This application claims priority to U.S. Provisional Application entitled, “METHOD AND APPARATUS FOR SOLENOID PROTECTION”, filed Feb. 13, 2004, having Ser. No. 60/543,995, which is hereby incorporated by reference in its entirety.

### FIELD OF THE INVENTION

The present invention relates generally to protective devices that support electrical and electromechanical apparatus. More particularly, the present invention relates to the use of self-resetting, thermally sensitive circuit interrupters to prevent damage to and field disablement of actuators.

### BACKGROUND OF THE INVENTION

Electromechanical actuators known as solenoids commonly employ electromagnetic coil assemblies and ferrous components, including frames and armatures, to convert electrical power to mechanical motion. As an example, a representative automobile engine starter solenoid uses a primary high-current electromagnetic coil to pull an armature into its actuated position against the force of a release spring, then disconnects the primary coil with a switch actuated by the armature, leaving a much weaker, lower current coil to hold the armature until power is removed, at which time the spring withdraws the armature.

In the above example, the primary coil moves the ferromagnetic armature far enough with respect to the ferromagnetic frame to form the two ferromagnetic elements into a substantially continuous loop. The primary coil is wrapped around a segment of this loop, so that the electric current flowing in the coil induces magnetic flux in the loop. Once the loop is closed, a much weaker electric current can induce enough magnetic field strength in the loop to hold the loop closed against the solenoid's release spring.

If the primary coil in the example fails to draw the armature fully into place, deenergizing of the primary coil may fail to occur, and the continued high power consumption may evolve considerable heat. Malfunctions in automotive applications, such as secondary failures, may occur due to excess heat. Since this example refers to an actuator whose operation is both momentary and intermittent, risk is substantially limited.

Physical processes similar to those in the example take place in many types of solenoids. Existing solenoid technology exhibits performance limitations, particularly with respect to devices intended for continuous operation. A factor limiting existing solenoid technology applies specifically to aircraft and other high performance applications. In such applications, minimization of the weight of each component is intrinsically desirable. Thus, unlike fixed or automotive applications, where a relatively massive assembly with other provisions for cooling can be used to draw heat away, the high weight efficiency desirable in an aircraft solenoid may decrease a system's intrinsic fault tolerance. A solenoid in an aircraft application may also be largely insulated, so that heat generated within a solenoid assembly may be prevented from flowing freely out of the assembly.

Another limiting factor in some applications can be a variable operating environment. Thus, while the automobile engine starter solenoid in the example operates within a largely fixed geometry, other solenoids may be installed in applications wherein blockage of the motional path for a solenoid armature can sometimes occur without any actual failures having taken place. This can lead to interference in the completion of the magnetic circuit, accompanied by prevention of timely switching to the lower, holding current operating mode. If this results in uninterrupted high current operation, a solenoid coil may heat up sufficiently to affect its operation, even if the current drawn by the coil is not outside an allowed range and thus excessive.

Accordingly, there is a need in the art for a solenoid protection apparatus that permits normal solenoid operation over the full range of allowed conditions, while activating a protecting state in specific abnormal environments, maintaining the protecting state as long as the abnormality persists and power remains applied, and resetting promptly to a noninterfering state once power is removed, the abnormality is resolved, and power is once again restored.

### SUMMARY OF THE INVENTION

The foregoing needs are met, to a great extent, by the present invention, wherein in one aspect an apparatus is provided that in some embodiments provides a protective device for solenoids and similar apparatus in the form of a positive temperature coefficient resistor (PTCR) assembled to the protected apparatus with a suitably configured thermal joint, so that the temperature of the PTCR closely tracks the temperature of the portion of the protected apparatus that is of interest, thereby providing fault protection with low configuration impact.

In accordance with one embodiment of the present invention, a protection device to protect a solenoid is presented. The protection device includes a thermally sensitive circuit interrupter, reset by power removal, having a first terminal and a second terminal, wherein the circuit interrupter is positioned in part in thermal contact with a region of a surface of an electromagnetic coil assembly in the solenoid, and wherein the electromagnetic coil assembly in the solenoid has a first coil assembly wire end and a second coil assembly wire end. The protection device further includes a clamp assembly configured to maintain continuous contact between the part of the circuit interrupter and the region of the surface of the electromagnetic coil. The protection device further includes an electrical circuit wherein the first coil assembly wire end and the first terminal of the circuit interrupter are electrically joined, and wherein the second coil assembly wire end and the second terminal of the circuit interrupter are configured as a first protected solenoid terminal and a second protected solenoid terminal, respectively.

In accordance with another embodiment of the present invention, a protection device for protecting an electrically powered apparatus against thermal overload is presented. The protection device includes means for detecting a condition of excessive temperature within an electrically powered apparatus, wherein the condition of excessive temperature results at least in part from application of an electrical signal to the electrically powered apparatus. The protection device further includes means for substantially interrupting a signal path by which the electrical signal is applied to the electrically powered apparatus in event of detecting the condition of excessive temperature. The protection device further includes means for maintaining the substantial interruption of the signal path for an indefinite interval, wherein the electrical signal is applied continuously during the indefinite interval, irrespective of an ending of the condition of excessive temperature within the electrically powered apparatus, and means for restoring the interrupted signal path, wherein preconditions of interruption of application of the electrical signal and of existence a condition of acceptable temperature are satisfied, whereinafter application of the electrical signal is permitted.

In accordance with yet another embodiment of the present invention, a method for developing a solenoid protected against thermal overload is presented. The method includes equivalently blocking normal armature operation in a solenoid, equivalently applying power to a coil assembly in the solenoid, establishing a temperature profile of the external boundaries of the blocked solenoid, localizing external hot spots on the solenoid correlated to internal hot spots thereof, identifying a positive temperature coefficient resistor (PTCR) type having a normal operation conductivity and an overtemperature protection activation characteristic suited to protecting the subject solenoid, configuring a clamping assembly whereby to attach the PTCR to the solenoid proximal to a hot spot thereof, and validating the suitability of the configuration of the clamping assembly and the PTCR for protection of the solenoid by environmental and operational testing.

There have thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. It is also to be understood that the phraseology and terminology employed herein, as well as the abstract, are for the purpose of description, and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a protected solenoid assembly, according to the preferred embodiment of the present invention.

FIG. 2 is a schematic diagram of a circuit using a protected solenoid.

FIG. 3 is an exploded view of components for protecting a solenoid.

FIG. 4 is a section view of the protected solenoid assembly of FIG. 1.

### DETAILED DESCRIPTION OF THE INVENTION

The invention will now be described with reference to the drawing figures, in which like reference numerals refer to like parts throughout. An embodiment in accordance with the present invention provides a protection function fitted to a solenoid so that the positive temperature coefficient resistor serving as the protection device has a temperature determined in large part by the temperature of a primary coil of the solenoid.

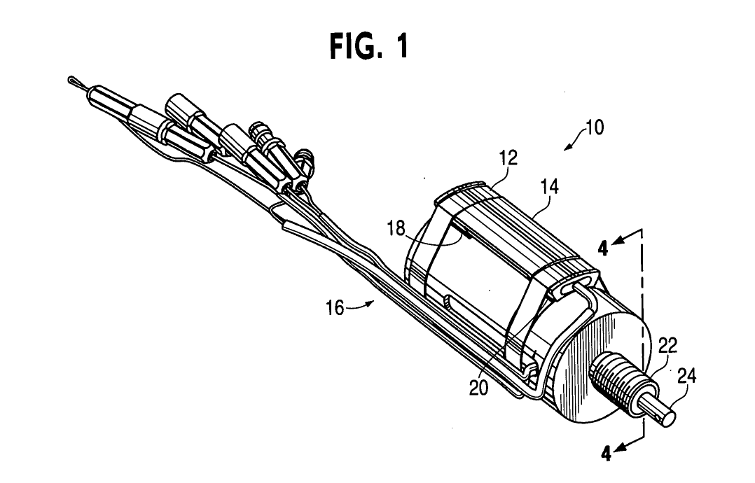

FIG. 1 illustrates a solenoid assembly 10 surrounded in part by one or more clamps 12 that provide retention force to hold in place a positive temperature coefficient resistor subassembly (PTCR) 14. A thermally conductive tape 18 is positioned at the location of the primary coil 16, between the solenoid and the PTCR 14. In some embodiments, the tape 18 is electrically insulating, and is resilient and deformable to a sufficient extent to increase its contact area with the PTCR 14 and the solenoid assembly 10. The tape 18 can additionally have adhesive on one or both sides. An additional adhesive-backed, electrically insulating tape 20 can be positioned at the opposite end of the PTCR 14 to provide stability to the assembly. In some embodiments, the second tape 20 can provide thermal insulation between the PTCR 14 and other heat sources within the solenoid. The solenoid assembly 10 in FIG. 1 has a threaded mounting boss 22 and an actuator shaft 24 coupled to the armature within the solenoid assembly 10. Shaft 24 is actuated when power is applied to the solenoid assembly 10. Actuation of shaft 24 may take the form of extension, retraction, or rotation when power is applied, depending on details of solenoid design.

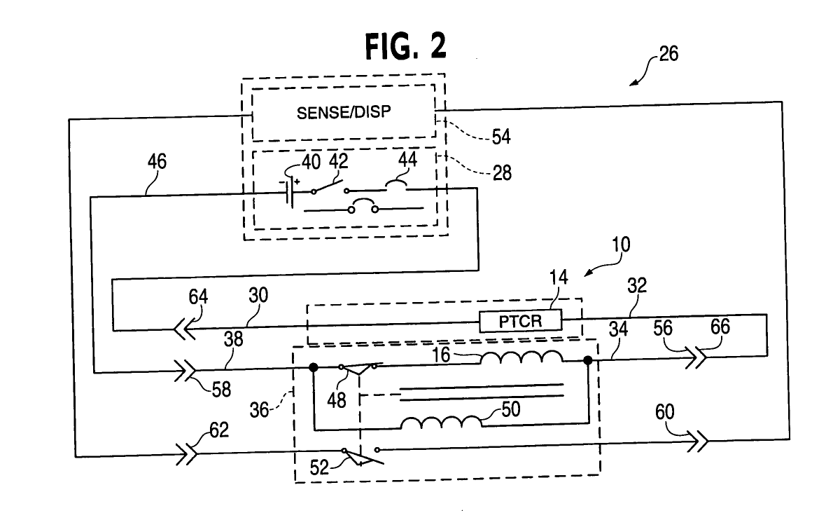

FIG. 2 is a schematic diagram 26 that depicts the electrical connection of a solenoid assembly 10 according to an embodiment of the invention. In the schematic, a power circuit from a power source 28, represented as a battery 40, a switch 42, and a circuit breaker 44, passes through the PTCR 14, through the solenoid internal circuit 38, and back to a power source return line 46. Within the solenoid assembly 10, the power enters at the first PTCR lead 30, passes through the PTCR 14 and out through the second PTCR lead 32 to the solenoid. The power further passes through a first solenoid wire 34, through the solenoid internal circuit 36, and out through the second solenoid wire 38. The internal circuit 36 includes a primary coil 16 in series with an end-of-travel switch 48, with that circuit configured in parallel with a holding coil 50. A second switch 52 is provided to permit operation of additional circuitry, such as an armature position status display 54. Connection of the solenoid assembly 10 to the system uses a solenoid male plug 56 and solenoid female receptacle 58, while the second switch uses a sense male plug 60 and sense female receptacle 62. The protective circuit uses a PTCR male plug 64 and a PTCR female receptacle 66. As assembled for protected use, the PTCR male plug 64 replaces the solenoid male plug 56 in connection to the power source 28, with the solenoid male plug 56 plugged into the PTCR female receptacle 66. The return path and sense path are unchanged.

Some types of positive temperature coefficient resistors are made up of blocks of carbon-impregnated polymer material to which conductors are connected. In normal use in a circuit, protective devices constructed from such materials can exhibit high conductivity, allowing them to be inserted without significant effect no normal operation. Self-heating of such a PTCR when subjected to overcurrent, however, causes the block of material to expand—that is, to increase rapidly in size with temperature rise. The expansion of the material, in turn, decreases the block's conductivity by orders of magnitude and largely shuts down current flow through the PTCR. A PTCR so used exhibits hysteresis—nonlinear reduction of the PTCR's conductivity that is substantially irreversible so long as even a small current continues to flow. The hysteresis is made possible because a typical power source continues to apply a substantially fixed voltage, while a load typically shows a largely constant resistance, and thus attempts to draw current at the original, undesirable rate. Any tendency for the PTCR to cool, shrink, and thus to lower its resistance once the PTCR itself has reduced circuit current flow causes current flow to increase again and reheat the PTCR, thereby achieving a stable operating point at which the load is effectively disabled. Shutting down the circuit and allowing the PTCR to cool allows the PTCR to revert to its nominal, high conductivity, so that power can be reapplied, which, if there is no intrinsic circuit fault, such as a load short circuit, typically allows nominal operation to resume.

A protected solenoid assembly 10 installed, for example, in an aircraft, is subjected to a broad ambient temperature range. On the other hand, the allowed operating temperature range for the solenoid assembly 10, while somewhat broader than the ambient temperature range for the solenoid assembly 10, is nonetheless comparatively narrow.

The term “nuisance tripping” as used below refers to disablement of the solenoid assembly 10 under nonfault conditions due to limitations of the protection circuit. In some embodiments, the solenoid assembly 10 needs to tolerate the equivalent of a high latitude or altitude cold soak, including indefinite storage at −40° C. prior to operation, with no nuisance tripping. The solenoid assembly 10 also needs to tolerate the equivalent of a low latitude, sun baked hot soak, including indefinite storage at +70° C. prior to operation, again with no nuisance tripping. In addition, the solenoid assembly 10 needs to tolerate inrush currents that are brief, excessive, but nondestructive, again with no nuisance tripping.

While an aircraft solenoid has a nominal operating voltage of 28 volts direct current (VDC), operation at voltages as low as 18 VDC and as high as 32 VDC at all temperatures is required. It is further to be understood that the conductivity of copper wire such as the coil of a solenoid varies with temperature, so that a specified solenoid may draw 20% less current, for example, at maximum temperature.

In addition to the foregoing, a protection circuit should trip before power dissipated within the solenoid assembly 10 can increase the temperature of the assembly 10 itself above the failure threshold of its component materials, such as softening or breakdown of wires, joints, insulation, nonmetallic structural elements, or embedment materials. For example, in a typical environment, if normal coil current in an unprotected solenoid is applied continuously, heat generated in the solenoid can cause the internal temperature to rise until failure of a weakest component. Under such circumstances, a coil wrapped on a plastic bobbin, for example, can eventually exceed virtually any temperature limit for the material of the bobbin, and ultimately exceed the limits for the insulation and the copper of the coil itself. If a known maximum temperature for the material from which the bobbin is made is, for example, 250° C., then an assigned goal to keep the bobbin temperature below 200° C. may be reasonable. Knowing that a particular hot spot on the exterior of the solenoid will consistently exceed, for example, 120° C. with applied power before any bobbin hot spots reach 200° C. can allow that exterior hot spot to be used as a monitoring point. Removing power promptly when the exterior hot spot temperature threshold is reached can protect the solenoid.

A variety of protection circuit configurations can be used once the principles and goals described above are established, but not all such circuits are equally useful. Additional criteria for a configuration include low overall complexity and low impact on existing end-user systems—that is, on systems previously configured assuming the use of unprotected solenoids. For example, a separate sensor circuit, using a thermistor, a thermocouple, or the like, can generate an alarm once the hot spot temperature threshold is exceeded, and the alarm can trip a remotely controllable circuit breaker, but such a configuration is complex and can require changes to multiple systems within an aircraft, such as adding wires to existing harnesses and connectors, changing the type of a circuit breaker, adding an active signal processing device such as a thermocouple detector, changing training methods and maintenance documents, and the like.

Reduced complexity compared to the above protection circuit can be achieved by the circuit shown in FIG. 2, wherein an additional attribute of a PTCR 14 is employed, namely that the PTCR 14 can be heated by any means—not only by electrical overcurrent—and can produce desired (non-nuisance) tripping behavior.

Thus, a PTCR 14 can protect a solenoid assembly 10 by thermal coupling of the PTCR 14 to the solenoid. Compared with some other methods for protecting a solenoid assembly 10, thermal coupling of a PTCR 14 is reliable. System impact is low, because protected retrofit solenoid assemblies 10 and retrofit protection circuit kits can in many cases fit in the locations in which unprotected predecessor solenoids can fit, while new solenoid assemblies 10 and new applications can include the protection provisions without additional accommodation. Electrical characteristics of protected solenoid assemblies 10, meanwhile, can be largely identical with those of unprotected solenoids.

When not subjected to fault conditions, protected solenoid assemblies 10 perform substantially like their unprotected equivalents. Since the physical dimensions that affect installation are in many embodiments unchanged, system assembly and solenoid replacement procedures are substantially unaffected. In normal operation, the protected solenoid operates in the same fashion as the unprotected equivalent when activated or deactivated.

In event of a blocked armature fault, however, the performance of the two assemblies differs significantly. Both protected and unprotected solenoids activate a switch 52 embedded in the solenoid assembly, the wires from which are brought out to the sense plug and receptacle 60 and 62, respectively, to indicate that the armature failed to reach its full-stroke position. The protected solenoid assembly 10 detects a hot spot problem and shuts off power to the solenoid assembly 10. In contrast, the unprotected solenoid assembly continues to receive current to its primary coil 16, and continues to heat up, possibly to the point of failure.

In using either an unprotected or a protected solenoid, an operator preferably shuts down a power source 28 once the full-stroke error indication is observed, after which the cause of the blockage can be corrected, and the power source 28 can be reactivated. With a protected solenoid, there is effectively no time criticality for the observation and correction of the full-stroke error indication. However, with an unprotected solenoid, internal component failure, electrical short circuit, emission of breakdown products, and the like may occur if the error indication is not observed promptly.

In many embodiments, a procedure change cautioning that a cool down period of specified duration is required after observing a protection event and prior to reactivation can be the only training and documentation impact.

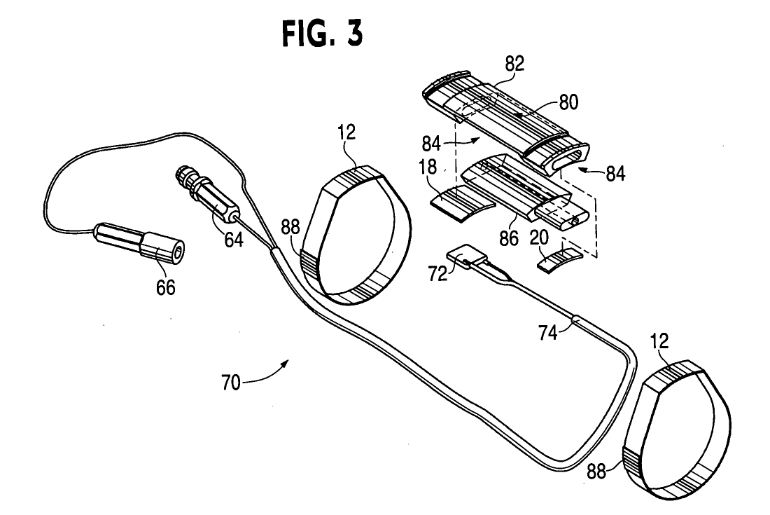

FIG. 3 is an exploded view of the components of a representative PTCR kit 70. Such a kit can be incorporated at the time of manufacture of the solenoid, or can be suitable for retrofit installation on an existing solenoid. The PTCR device 72 is selected as described below, then wired, for example, to a two-conductor cable 74 terminated in a PTCR male plug 64 and a PTCR female receptacle 66. The PTCR device 72 is inserted into the cavity 80 in the PTCR housing 82, after which a potting compound is poured to fill the housing voids 84, taking the shape 86 indicated. As also shown in FIG. 1, a thermally conductive, double-sided adhesive tape 18 and a thermally nonconductive, double-sided adhesive tape 20 are affixed. The device, after testing, can be provided to a user. For final assembly to an existing solenoid, the device, with tapes 18 and 20, respectively, attached, is placed in position on the solenoid, and the clamps 12 are positioned and tightened using the securing devices 88. The PTCR female receptacle 66 is plugged to the solenoid male plug 56 as shown in FIG. 1. This completed protected solenoid assembly 10 can be subjected to a final test sequence and returned to service.

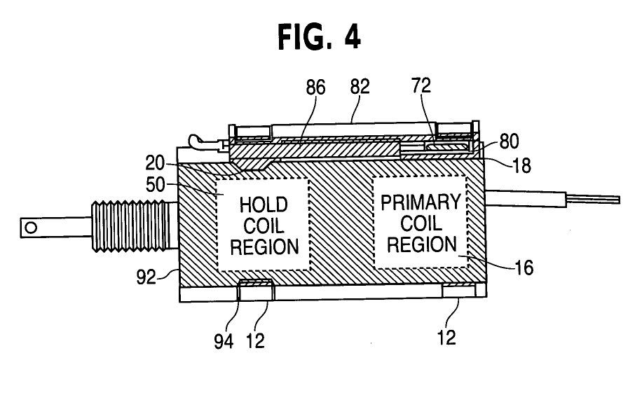

FIG. 4 is a section view of the protected solenoid assembly 10 of FIG. 1. The view indicates approximately the locations of the primary coil 16 and the holding coil 50. It is to be understood from this view that the thermally conductive tape 18, also shown in FIGS. 1 and 3, enhances thermal coupling between the primary coil 16 and the PTCR device 72, serving to increase the response speed to an overload. The thermally nonconductive tape 20, likewise shown in FIGS. 1 and 3, reduces thermal coupling between the holding coil 50 and the PTCR device 72. The nonconductive tape 20 serves to prevent nuisance tripping due to normal operation over the full temperature range for the protected solenoid assembly 10.

FIG. 4 further shows a representative solenoid body 92 that has a circumferential recess 94, also visible in FIG. 1, which recess 94 is useful for keying the PTCR housing 82; other solenoid bodies, such as bodies lacking such a keying feature, may require a different PTCR housing shape to assure stable positioning and proper alignment.

Applying a PTCR 14 to a specific solenoid assembly 10 can be broken into steps. The allowable current range for the primary coil 16 and holding coil 50 for the solenoid assembly 10 can be identified. From these values, analysis and/or measurement can determine the actual exterior hot spot locations on the solenoid type, at representative ambient temperatures. Effects of the thermally conductive tape 18, the insulating tape 20, the clamps 12, and of the overall shape of the PTCR 14 are preferably included in the characterization of the hot spots. The solenoid's current range can then be matched to likely PTCR devices that can be fitted into a PTCR housing 82. In some instances, physically blocking the armature, applying power, and measuring interior and exterior temperatures, such as with attached and embedded thermocouples, a succession of infrared photographs, or equivalent thermograms, may be preferred. In other instances, an analytical model, such as finite element analysis, that simulates the characterization process with a mathematical equivalent, may be preferred, either as a first step or as a complete development process.

Once the preliminary design of a protected solenoid is established as described above, final design can proceed. This step typically entails final design of a PTCR housing 82 to affix the PTCR device 72 at a chosen location on the specific style of solenoid to be protected. The location may be at or near a hot spot. Wiring configurations in some embodiments, such as the kit shown in FIG. 3, may permit a PTCR 14 to be added to a solenoid assembly without requiring changes to the wiring configuration of an aircraft into which the assembly is to be installed.

Following final design, design verification in prototype and production is preferably performed. It is to be understood that an overtemperature event is the heating of a component of the solenoid assembly 10 to a level that exceeds a design goal for that component. A design is validated if following conditions are met with the solenoid assembly 10 installed in a simulated application location:

First, the protected solenoid assembly 10, powered repeatedly over the full voltage and ambient temperature range, exhibits no nuisance tripping and no overtemperature events in normal use.

Second, blockage of the solenoid armature, for example by preventing full stroke of the actuator shaft 24, causes the desired circuit interruption after power is applied, without generating overtemperature events, over the full voltage and ambient temperature range.

Third, the protected solenoid assembly 10 can remain in the interrupted state indefinitely with power applied, without spontaneously resetting, and without component damage, including foreseeable voltage and ambient temperature changes.

Fourth, removal of power permits resetting of the PTCR 14 and restoration of normal function, in the absence of actuator shaft 24 blockage, over the full voltage and ambient temperature range.

Fifth, the protection function is repeatable an indefinite number of times.

Sixth, the protected device satisfies other test criteria for the solenoid assembly 10 such as shock and vibration, water and chemical exposure, storage temperature range, changes in atmospheric pressure, and the like.

Thus, a solenoid that can operate in a wide ambient temperature range with a narrow component survival range has been shown, along with a method for developing a new application of a PTCR to an existing or new electromechanical or electronic device for such an environment.

It is to be understood that electrical and electromechanical devices can have thermally activated protective PTCRs as embedded elements within the outer casings of the devices. High thermal conductivity paths to the PTCRs from vulnerable components (the primary coil assembly within a solenoid, for example) and low thermal conductivity paths from nonvulnerable components (the secondary coil assembly within a solenoid, for example) provide protection while preventing nuisance tripping. The bypass feature for testing, which is implemented with multiple single-pin connectors in a surface-attached PTCR assembly, can be realized by providing jumper capability, thereby allowing bridging across and thus bypassing of an embedded PTCR.

Although circuit protection accomplished by employing positive temperature coefficient resistors (PTCRs) as shown is useful in applications such as aircraft door latch solenoids, the circuit protection concept can be widely applied to extend protection beyond the intrinsic capability of PTCRs as ordinarily applied for overcurrent protection. Application of PTCRs to support both electromechanical and electronic components and housed component assemblies that may have relatively narrow thermal operating ranges but that need to be survivable in relatively broad ambient thermal ranges can apply to consumer, scientific, industrial, and transportation regimes, as well as in military, law enforcement, and other environments where limitation of component stress to consistently prevent failure without complex protection circuitry may be desirable.

The many features and advantages of the invention are apparent from the detailed specification, and, thus, it is intended by the appended claims to cover all such features and advantages of the invention that fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, that fall within the scope of the invention.

1. A protection device to protect a solenoid, comprising:
a thermally sensitive circuit interruptor having a first terminal and a second terminal, wherein a portion of the circuit interrupter is positioned in contact with a surface of a housing enclosing the solenoid at least in part, and wherein an electromagnetic coil assembly in the solenoid has a first coil assembly wire end and a second coil assembly wire end;
a clamp assembly configured to maintain contact between the portion of the circuit interrupter and the region of the surface of the housing; and
an electrical circuit wherein the first coil assembly wire end and the first terminal of the circuit interrupter are electrically linked, and wherein the second coil assembly wire end and the second terminal of the circuit interruptor are configured as a first protected solenoid terminal and a second protected solenoid terminal, respectively.

2. The protection device of claim 1, further comprising at least one electrical circuit connector, wherein the first solenoid terminal is electrically joined to a first connector contact and the second solenoid terminal is electrically joined to a second connector contact.

3. The protection device of claim 1, further comprising a plurality of insulated electrical conductors extending from the solenoid, wherein the first protected solenoid terminal is electrically joined to a first member of the plurality of insulated electrical conductors and the second protected solenoid terminal is electrically joined to a second member of the plurality of insulated electrical conductors.

4. The protection device of claim 1, wherein the first protected solenoid terminal is configured to permit the first solenoid terminal to be linked electrically to a first conductor external to the protected solenoid, and wherein the second protected solenoid terminal is configured to permit the second solenoid terminal to be linked electrically to a second conductor external to the protected solenoid.

5. The protection device of claim 1, further comprising a thermally conductive, electrically insulating barrier positioned in contact with the surface of the housing.

6. The protection device of claim 5, wherein the barrier comprises at least one selected from the group consisting of:
a tape form;
a property of resilience;
a characteristic of deformability; and
at least one adhesive surface.

7. The protection device of claim 1, wherein the thermally sensitive circuit interrupter further comprises a positive temperature coefficient resistor.

8. The protection device of claim 1, wherein the thermally sensitive circuit interrupter is configured to be insensitive to momentary electrical overload.

9. The protection device of claim 1, wherein the solenoid further comprises an armature configured to activate on the application of an electrical signal between the first coil assembly wire end and the second coil assembly wire end of the electromagnetic coil assembly.

10. The protection device of claim 9, wherein the thermally sensitive circuit interrupter is configured to be in a high conductivity state at a low temperature and in a low conductivity state at a high temperature.

11. The protection device of claim 14, wherein the thermally sensitive circuit interruptor is configured to maintain the low conductivity state, once established, in a circuit in which the electrical signal is continuously applied.

12. The protection device of claim 11, wherein the thermally sensitive circuit interrupter is configured to revert to the high conductivity state when the temperature of the thermally sensitive circuit interrupter is a low temperature.

13. The protection device of claim 1, wherein the clamp assembly is configured to retain the protection device to the housing.

14. A protection device for protecting an electrically powered apparatus against thermal overload, comprising:
means for detecting a condition of excessive temperature within an electrically powered apparatus, wherein the condition of excessive temperature results at least in part from application of an electrical signal to the electrically powered apparatus;
means for interrupting the electrical signal applied to the electrically powered apparatus in response to detecting the condition of excessive temperature;
means for maintaining the interruption of the electrical signal during an interval, wherein the electrical signal is applied during the interval; and
means for restoring the interrupted signal path in response to interruption of application of the electrical signal and establishment of a condition of an acceptable temperature.

15. The protection device of claim 14, further comprising:
means for attaching the means for interrupting the signal path to the electrically powered device;
means for electrically insulating the electrically powered device from the means for interrupting the electrical signal; and
means for conducting heat from the electrically powered device to the means for interrupting the signal path.

16. The protection device of claim 15, wherein the means for attaching further comprises a clamp.

17. A method for protecting a solenoid against thermal overload, comprising:
establishing a temperature profile of an external boundary of a solenoid;
localizing an external hot spot on the solenoid;
interrupting an electrical signal to the solenoid with a positive temperature coefficient resistor (PTCR) device which is attached to the solenoid and is configured to interrupt the signal to the solenoid in the presence of overheating;
configuring a clamping assembly to attach the PTCR to the solenoid.

18. The method of claim 17, wherein configuring the clamping assembly further comprises interposing a thermally conductive material between the PTCR and the solenoid proximal to the hot spot.

19. The method of claim 18, wherein the interposed thermally conductive material further comprises at least one selected from the group consisting of:
an electrical insulator;
a tape form;
a characteristic of resilience;
a characteristic of deformability; and
at least one adhesive surface.

20. The method of claim 17, wherein configuring the clamping assembly further comprises interposing a thermally nonconductive material between the PTCR and the solenoid at a location differing from that of the hot spot.

21. The method of claim 17, wherein configuring the clamping assembly further comprises providing a clamping assembly shape conformal to and in part interlocking with the solenoid.
